(19) United States
(12) Patent Application Publication
(10) Pub. No.: US 2008/0151739 A1
(43) Pub. Date: Jun. 26, 2008

(54) Content Replication Deterrent Method on Optical Discs

(75) Inventors: Richard H Selinfreund, Terre Haute, IN (US); Scott Gerger, Des Moines, IA (US); Donald R. Goyette, Plainfield, CT (US); Rakesh Vig, Durham, CT (US); Lunzhong Li, New London, CT (US)

Correspondence Address: KELLEY DRYE & WARREN LLP, 400 ALTLANTIC STREET , 13TH FLOOR, STAMFORD, CT, 06901, US

(73) Assignee: Verification Technologies, Inc., Essex, CT (US)

(21) Appl. No.: 12/035,025

(22) Filed: Feb. 21, 2008

Related U.S. Application Data
(63) Continuation of application No. 10/371,593, filed on Feb. 21, 2003.
(60) Provisional application No. 60/371,593, filed on Apr. 10, 2002.

(51) Int. Cl. G11B 7/24

(52) U.S. Cl. 369/275.1

(57) ABSTRACT

An article of manufacture comprising an optical disc readable by an optical reader. The disc provides content replication deterrence by placing an optical state change security material in the tracking control region of the disc.

### CROSS-REFERENCE TO RELATED APPLICATIONS

This application is a Continuation Application of U.S. patent application Ser. No. 10/410,318, filed Apr. 9, 2003, which claims the benefit of U.S. Provisional Application No. 60/371,593 filed on Apr. 10, 2002, the contents of which are incorporated by reference herein.

### FIELD OF INVENTION

The present invention generally relates to copy-protected optical information recording media and methods for manufacturing the same. More specifically, the present invention relates to the manufacture of an optically readable digital storage medium that protects the information stored thereon from being copied using conventional optical medium readers, such as CD and DVD laser readers, but permits reading of the information from the digital storage media by the same readers.

### BACKGROUND OF THE INVENTION

Data is stored on optical media by forming optical deformations or marks at discrete locations in one or more layers of the medium. Such deformations or marks effectuate changes in light reflectivity. To read the data on an optical medium, an optical medium player or reader is used. An optical medium player or reader conventionally shines a small spot of laser light, the “readout” spot, through the disc substrate onto the data layer containing such optical deformations or marks as the medium or laser head rotates.

In conventional “read-only” type optical media (e.g., “CD-ROM”), data is generally stored as a series of “pits” embossed with a plane of “lands”. Microscopic pits formed in the surface of the plastic medium are arranged in tracks, conventionally spaced radially from the center hub in a spiral track originating at the medium center hub and ending toward the medium's outer rim. The pitted side of the medium is coated with a reflectance layer such as a thin layer of aluminum or gold. A lacquer layer is typically coated thereon as a protective layer.

The intensity of the light from a read-only medium's surface measured by an optical medium player or reader varies according to the presence or absence of pits along the information track. When the readout spot is over a land, more light is reflected directly from the disc than when the readout spot is over a pit. A photodetector and other electronics inside the optical medium player translates the signal from the transition points between these pits and lands caused by this variation into the 0s and 1s of the digital code representing the stored information.

The vast majority of commercially-available software video, audio, and entertainment pieces available today are recorded in read-only optical format. One reason for this is that data replication onto read-only optical formats is significantly cheaper than data replication onto writable and rewritable optical formats. Another reason is that read-only formats are less problematical from a reading reliability standpoint. For example, some CD readers/players have trouble reading CD-R media, which has a lower reflectivity, and thus requires a higher-powered reading laser, or one that is better “tuned” to a specific wavelength.

Optical media of all types have greatly reduced the manufacturing costs involved in selling content such as software, video and audio works, and games, due to their small size and the relatively inexpensive amount of resources involved in their production. They have also unfortunately improved the economics of the pirate, and in some media, such as video and audio, have permitted significantly better pirated-copies to be sold to the general public than permitted with other data storage media. Media distributors report the loss of billions of dollars of potential sales due to high quality copies.

Typically, a pirate makes an optical master by extracting logic data from the optical medium, copying it onto a magnetic tape, and setting the tape on a mastering apparatus. Pirates also sometimes use CD or DVD recordable medium duplicator equipment to make copies of a distributed medium, which duplicated copies can be sold directly or used as pre-masters for creating a new glass master for replication. Hundreds of thousands of pirated optical media can be pressed from a single master with no degradation in the quality of the information stored on the optical media. As consumer demand for optical media remains high, and because such medium is easily reproduced at a low cost, counterfeiting has become prevalent.

WO 02/03386 A2, which asserts common inventors to the present application, discloses methods for preventing copying of data from an optical storage media by detecting optical dis-uniformities or changes on the disc, and/or changes in read signal upon re-reading of a particular area on the optical storage medium. Software control is used to deny access to content if the change in read signal is not detected at the position on the disc wherein the re-reading change is expected to occur. Such method may employ light sensitive or other materials adapted to change state upon interaction with the laser of the optical reader so as to affect read after or during exposure to the laser of the optical reader.

An inherent problem with copy-protection based upon software designed to cause re-read based upon the detection of physical markers on the disc is the software itself. First, the detection software is most conveniently stored on the disc itself taking up space that could be devoted to content storage. Second, history has shown that software-based copy-protection schemes have been rapidly avoided by hackers who have been more than willing to share their finds with others. Even encrypted software has not been found to prevent the hacker's prowess in hacking code.

In practice, directed placement of materials that change state upon interaction with the laser on the optical disc pose problems. In WO 02/03106, which also claims common inventors to the present invention, there are disclosed methods for applying such materials in the manufacturing process of optical discs. Such methods include methods for the precise deposition of such materials with respect to the pits and lands on the optical disc. The problem with such precise placement deposition methods are that they require exacting controls in the actual optical disc manufacturing process, and add to the cost of fabricating an optical disc.

Another problem associated with placement of such materials is the possibility of unintended state changes occurring owing to exposure to ambient light sources, as opposed to exposure to the optical reader laser itself. Such unintended state changes may interfere with the appropriate functioning of the copy-protection system.

There is a need therefore for a copy-protected optical medium, which does not depend on encryption codes, or special hardware to cause re-sampling of a disc to permit access to content, that does not require exacting deposition of phase change materials onto the disc, and that reduces unintended phase changes due to exposure to ambient light sources. The copy-protected media should also be readable by the large number of existing optical medium readers or players without requiring modifications to those devices.

### DEFINITIONS

“Micro-deposition”: a deposition of a size equal to, or smaller than, the diameter of the reading beam of an optical reader used to read an optical medium.

“Macro-deposition”: a deposition of a size larger than that of a micro-deposition.

“Optical Medium”: a medium of any geometric shape (not necessarily circular) that is capable of storing digital data that may be read by an optical reader.

“Optical Reader”: a Reader (as defined below) for the reading of Optical Medium.

“Reader”: any device capable of detecting data that has been recorded on an optical medium. By the term “reader” it is meant to include, without limitation, a player. Examples are CD and DVD readers.

“Read-only Optical Medium”: an Optical Medium that hats digital data stored in a series of pits and lands.

“Recording Layer”: a section of an optical medium where the data is recorded for reading, playing or uploading to a computer. Such data may include software programs, software data, audio files and video files.

“Re-read”: reading a portion of the data recorded on a medium after it has been initially read.

“Optical State Change Security Material”: refers to an inorganic or organic material used to authenticate, identify or protect an Optical Medium by changing optical state from a first optical state to a second optical state. The optical state change of the optical state change security material may be random or non-random.

“Optically-Changeable Security Material”: refers to an inorganic or organic material used to authenticate, identify or protect an Optical Medium by transiently changing optical state between a first optical sate and a second optical state and that may undergo such change in optical state more than one time upon read of the Optical Medium by an Optical Reader in a manner detectable by such Optical Reader. The optical state change of the optically-changeable security material may be random or non-random.

“Permanent Optically-Changeable Security Material”: refers to an Optically-Changeable Security Material that undergoes change in optical state for more than thirty times upon read of the Optical Medium by an Optical Reader.

“Temporary Optically-Changeable Security Material”: refers to an Optically-Changeable Security Material that undergoes change in optical state for less than thirty times, but more than once, upon read of the Optical Medium by an Optical Reader.

For the purpose of the rest of the disclosure it is understood that the terms as defined above are intended whether such terms are in all initial caps, or not.

### SUMMARY OF THE INVENTION

In one embodiment of the present invention there is provided a copy-protected optical medium, comprising optical state change security materials, that do not require mark authentication software designed to re-seek the mark after an initial read and/or that reduces or prevents unintended optical state changes due to exposure to ambient light and/or that may be manufactured without precise micro-placement of the optical state change security materials.

In another embodiment of the present invention there is provided methods and optical discs for copy-protection that incorporate physical aberrations on the disc that interfere with copying of the disc using standard optical disc reader protocols but that permits read of the content data on the disc by way of algorithms on the disc, or in the hardware reading the disc, that recognize the physical aberrations and permit access to the content on such basis of the recognition of the physical aberration or upon failure to recognize the physical aberration upon reread.

In another embodiment of the present invention, there is provided a method of algorithmic authentication of a disc to provide access to content that is based on the detection of an uncorrectable error produced by an optical state change security material applied in a macro manner, that is, not at the resolution of the pit/land level. In a preferred embodiment the uncorrectable error is of such a degree that it interferes with standard copy protocols. The optical state change security material may be selected such that in its first optical state it produces an uncorrectable error, but in its second optical state (the change in optical state preferably being due to exposure to the optical reader laser) the underlying data is able to be read and a valid data state is detected. The authentication software may be designed to recognize the change from an uncorrectable error to a valid data state and to permit access to the content only upon recognition of such change. When the optical state change security material is an optically-changeable security material, the change from the first optical state to the second optical state may be non-random (change occurring in a defined manner after actuation) or may be random (change occurring in a non-defined manner). When positioned on the medium to cause a change at the bit level, an optically-changeable security material causing a random change may be preferred for purposes of more stringent encryption.

In another embodiment of the present invention there is provided a method for protecting the optical state change security material from undergoing an unintended optical state change due to ambient conditions. To provide such protection, there is provided material that shield the optical state change security material from the environment, and particularly material that interferes by reacting with the parameter of the environment that is effectuating the state change. Most often the material is a light filter material that interacts with ambient light waves that cause the optical state change security material to change state. For example ultraviolet or infrared absorbing or deflecting materials lay be used to prevent activation by such waves. Such material may be placed within the substrate of the optical disc itself, in a layer supra or infra to the optical state change material, such as being added to a lacquer layer that is applied over the pitted side of the optical disc. Of course, the filter typically should not prevent detection by the optical reader of the optical state change.

In another embodiment of the present invention mere is provided an optical disc copy-protection method that employs micro-placement, that is placed at pit/land resolution, such that re-seek algorithms that are internal to drive function are used. For example, the optical state change security material may be micro-deposited at select positions in the tracking control zones of the optical disc in a maimer that the tracking control is “fooled” by the first optical state of the material to look at a “spoof address” for data that does not exist at such address. The re-seek algorithms internal to the drive will cause a re-read of the tracking control instructions associated with micro-deposition. If the optical state change security material is selected such that its second state allows the true underlying data to be read, aid the material is further selected to be in its second state upon re-read, the tracking control data will be read correctly directing read of the correct address, and the content will be able to read. In a preferred embodiment the material is placed at the subcode level in the lead-in zone thus affecting the table of contents, for example. The material may be placed at the microlevel in the CRC field.

In one embodiment of the invention there is disclosed a method for fabricating an optical medium readable by an optical reader, the method comprising the steps of: (a) molding a substrate so as to have a first major surface with information pits and information lands thereon and a second major surface that is relatively planar; (b) applying a reflective material over the first major surface so as to cover a portion of the first major surface but not all of said surface; (c) applying an optical state change security material capable of converting from a first optical state to a second optical state upon exposure to the laser of an optical reader to the portion of the first major surface of step (b) that is devoid of the reflective material; (d) applying a reflective material over that portion of the first major surface that the optical state change security material is positioned in step (c). The optical state change security material may be positioned and of such character and quantity so as to produce an uncorrectable or correctable error in either its first or second optical states. The optical state change security material may be an optically-changeable security material that undergoes a transient change in optical state, and may be applied in step (c) by spin coating.

In another embodiment of the invention there is disclosed a method for authenticating an optical storage medium having an optical structure representative of a series of bits, the method comprising: (a) reading the optical storage medium to determine whether there is an uncorrectable or correctable error at a pre-selected locus; (b) re-reading the optical storage medium at the pre-selected locus to determine if upon re-read there is valid data at the pre-selected locus; (c) authenticating the optical storage medium if an uncorrectable or correctable error, respectively, is detected in step (a) and valid data in step (b). The method may also comprise the further step of: (d) prohibiting read of the series of bits represented by the optical data structure, or portion thereof, if the optical storage medium is not authenticated at step (c).

In yet another embodiment of the present invention, there is disclosed a method for dissuading the illicit copying of data stored on an optical data storage medium comprising a series of optical deformations representative of data, the method comprising the steps of: (a) introducing an uncorrectable or correctable error on the optical data storage medium at a mapped location; (b) incorporating into the data stored on the optical data storage medium a program instruction set for detecting the uncorrectable or correctable error, as the case may be, at the mapped location and for effectuating read of data stored on the optical data storage medium when the uncorrectable/correctable error is determined to be present at the mapped location on the optical data storage medium. The uncorrectable/correctable error may be transient in nature. The uncorrectable/correctable error may be caused by deposition of an optical state change security material, such as permanent or temporary optically-changeable security material.

In another embodiment there is disclosed an article of manufacture comprising an optical disc, the optical disc including an optical state change security material placed in the tracking control region of the disc. The optical state chance security material may be optically-changeable security material, such as a permanent or temporary optically-changeable security material. The optical state change security material may be placed in subcode in the lead-in section of the optical disc, and in particular in the CRC field.

Also disclosed is an optical disc comprising: a substrate having one or more information pits and lands thereon readable as digital data bits by an optical reader; an optical state change security material positioned over, under, in, or on one or more information pits and lands; and a material capable of interacting with ambient light waves that could effectuate a change in the optical state of the optical state change security material, the material capable of interacting with ambient light being positioned in or on the substrate so as to shield the optical state change security material from light waves that could effectuate a change in the optical state of the optical state change security material. The material capable of interacting with ambient light waves may be located within the substrate or may be located, for example, in a layer lying supra or infra to the optical state change security material. It is, of course, preferred that the shielding material be selected so as not to interfere with the detection of the optical state change of the optical state change security material by the optical reader.

And yet another embodiment of the present invention is an optical disc comprising: a substrate having a first major surface with information pits and information lands thereon readable by an optical reader and a second major surface that is relatively planar; an optical state change security material applied in an annular ring positioned on the first major position at a position outside of the lead-in or lead-out portions of the disc.

And yet another embodiment of the present invention is an optical storage medium comprising: a substrate having a first major surface with information pits and information lands thereon readable by an optical reader and a second major surface that is relatively planar; an optical state change security material applied at a position outside of the lead-in or lead-out portions of the disc on the first major surface in a manner to form discernable words when the optical state change security material is in its first optical state or its second optical state. The optical state change security material may be opaque in its first optical state and translucent in its second optical state, and vice-versa.

### BRIEF DESCRIPTIONS OF DRAWINGS

The accompanying drawings, which are incorporated in and constitute part of the specification, illustrate presently preferred embodiments of the invention, and together with the general description given above and the detailed description of the preferred embodiments given below, serve to explain the principles of the invention.

FIG. 1A (prior art) illustrates the different types of tracks that are conventionally fund on an optical disc;

FIG. 1B (prior art) illustrates the different zones or areas found on a DVD read-only optical disc;

FIG. 2 illustrates starting materials and desired end-products that represent preferred optical state change security materials;

FIG. 3 illustrates starting materials and desired end-products that represent preferred optical state chance security materials;

FIG. 4 illustrates starting materials and desired end-products that represent preferred optical state change security materials;

FIG. 5 illustrates a preferred disc embodiment incorporating an optical state change security material in a human readable message applied along the outer edge of an optical disc; and

FIG. 6 illustrates a preferred disc embodiment incorporating an optical state change security material in non-human readable form spin-coated on the disc.

### DETAILED DESCRIPTION OF THE INVENTION

The present invention provides in one embodiment a copy-protected optical medium comprising optical state change security materials, that does not require exacting micro-deposition of optical state change security materials onto the disc and that reduces unintended phase changes due to exposure to ambient light sources. In another embodiment it provides a microdeposition technique which does not depend on encryption codes, or special hardware, to cause re-sampling of the area on which the optical state change security material is located.

All optical discs employ error management strategies to eliminate the effect of defect-induced errors. It has been found that even with the most careful handling, it is difficult to consistently manufacture optical discs in which the defect-induced error rate is less than 10.sup.-6. Optical recording systems are typically designed to handle a bit-error rate in the range of 10.sup.-5 to 10.sup.-4. The size of the defect influences the degree of error associated with the defect. Thus some defects create such a marginal signal disturbance that the data are almost always decoded correctly. Slightly smaller defects might induce errors hardly ever. Error management strategies include powerful error-correction codes (ECC). ECC are algorithms that attempt to correct errors due to manufacturing defects such that the optic disc works as intended. Error detection methods are conventionally based on the concept of parity. ECCs exist which are simultaneously optimized for both long and short error bursts such as the Reed-Solomon (RS) codes. If code words arc interleaved before recording, a very long burst may be reduced to a manageable number of errors within each recovered code word. The cross-interleaved Reed-Solomon code (CIRC) from the CD format encodes the data first, using an RS code C.sub.1. Twenty-four C.sub.1 code words are interleaved and then encoded using a RS Code, C.sub.2. When the nature of a failure is such that the ECC is insufficient to perform the required correction, the error is referred to as an “uncorrectable error.”

Placement of optical state change security materials at the pit and land level is difficult and requires exacting control. It has been discovered that such exacting micro-placement is not necessary for robust authentication of the optical disc in the employment of the methods described in WO 02/03106, but rather that authentication of the optical disc can be made as robustly using macro depositions, that is placement of the compound in a manner without having pit/land resolution, of the optical state change security materials placed either on the laser incident surface or the pit-side of the optical disc using most optical drives.

Macro-depositions of optical state change security material can be integrated with the optical medium in a manner to from “uncorrectable errors” that can be detected for example by software designed to permit access to underlying content data only upon determination that the macro deposition is present at a certain position on or in the disc. Preferably the optical state change security material provides for a valid data state read in a first optical state, but an uncorrectable read error in a second optical state, making it significantly more difficult for a would-be copier of the disc to reproduce an operable disc by incorporating an uncorrectable error, such as a physical deformation, into the disc. As would be understood by one of ordinary skill in the art, micro-depositions may also be used to cause uncorrectable errors. For example, micro depositions of such size as to kill a data group may cause correctable errors fixable by C.sub.1/C.sub.2, but if applied to kill enough groups may cause an uncorrectable error detectable by such software. Preferably the optical state change security material is selected such that it causes a valid data read in one state and an uncorrectable data read error in a second state. For example, the first state detected could be an uncorrectable error read, while after a period of time after activation of the material by the optical read laser the second state could lead to a valid data read, which may comprise correctable errors.

Macro-deposition placement of optical state change security material in such method may be either on the laser incident surface, or on the pit surface. Macro-depositions may comprise application against the entire surface of the disc. Macro-depositions may be applied after the production of the discs, or may be applied more advantageously during manufacture of the optical disc to further thwart would-be copiers.

Interference/reflectivity type optical media comprising a read-only format arc typically manufactured following a number of defined steps.

Data to be encoded on the read-only optical medium is first pre-mastered (formatted) such that data can be converted into a series of laser bursts by a laser, which will be directed onto a glass master platter. The glass master platter is conventionally coated with a photoresist such that when the laser beam from the LBR (laser beam recorder) hits the glass master a portion of the photoresist coat is “burnt” or exposed. After being exposed to the laser beam, it is cured and the photoresist in the unexposed area rinsed off. The resulting glass master is electroplated with a metal, typically Ag or Ni. The electroformed stamper medium thus formed has physical features representing the data. When large numbers of optical media of the disc-type are to be manufactured, the electroformed stamper medium is conventionally called a “father disc”. The father disc is typically used to make a mirror image “mother disc,” which is used to make a plurality of “children discs,” often referred to as “stampers” in the art. Stampers are used to make production quantities of replica discs, each containing the data and tracking information that was recorded, on the glass master. If only a few discs are to be replicated (fewer than 10,000) and time or costs are to be conserved, the original “father” disc might be used as the stamper in the mould rather than creating: an entire “stamper family” consisting of a “father”, “mother” and “children” stampers.

The stamper is typically used in conjunction with an injection molder to produce replica media. Commercially-available injection molding machines subject the mold to a large amount of pressure by piston-driven presses, in excess of 20,000 pounds.

In the read-only optical medium molding process, a resin is forced in through a sprue channel into a cavity within the optical tooling (mold) to form the optical medium substrate. Today most optical discs are made of optical-grade polycarbonate which is kept dry and clean to protect against reaction with moisture or other contaminants which may introduce birefringence and other problems into the disc, and which is injected into the mold in a molten state at a controlled temperature. The format of the grooves or pits is replicated in the substrate by the stamper as the cavity is filled and compressed against the stamper. After the part has sufficiently cooled, the optical tooling mold is opened and the sprue and product eject are brought forward for ejecting the formed optical medium off of the stamper. The ejected substrate is handed out by a robot arm or gravity feed to the next station in the replication line, with transport time and distance between stations giving the substrate a chance to cool and harden.

The next step after molding in the manufacture of a read-only optical medium is to apply a layer of reflective metal to the data-bearing side of the substrate (the side with the pits and lands). This is generally accomplished by a sputtering process, where the plastic medium is placed in a vacuum chamber with a metal target, and electrons are shot at the target, bouncing individual molecules of the metal onto the medium, which attracts and holds them by static electricity. The sputtered medium is then removed from the sputtering chamber and spin-coated with a polymer, typically a UV-curable lacquer, over the metal to protect the metal layer from wear and corrosion. Spin-coating occurs when the dispenser measures out a quantity of the polymer onto the medium in the spin-coating chamber and the medium is spun rapidly to disperse the polymer evenly over its entire surface.

After spin-coating, the lacquer (when lacquer is used as the coat) is cured by exposing to UV radiation from a lamp, and the media are visually inspected for reflectivity using a photodiode to ensure sufficient metal was deposited on the substrate in a sufficiently thick layer so as to permit every bit of data to be read accurately. Read-only optical media that fail the visual inspection are loaded onto a reject spindle and later discarded. Those that pass arc generally taken to another station for labeling or packaging. Some of the “passed” media may be spot-checked with other testing equipment for quality assurance purposes.

When macro-deposition placement of the material is employed it is generally preferred to apply the same to the pit side as the laser power density at the pit surface is approximately 1000 times that at the substrate surface allowing for better control over activation time. Further, if the material is placed under the lacquer coat that is conventionally placed on the pit side the chemistry of the material is far more difficult to reverse engineer. Servo disturbances due to the material are also minimized by such placement.

Application of the macro-deposition should advantageously take into account optical disc format.

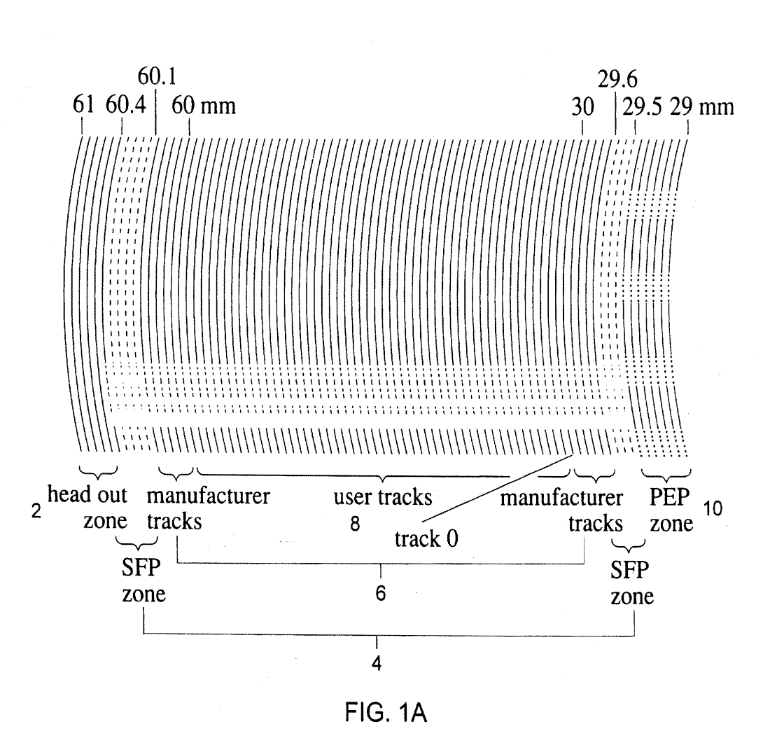

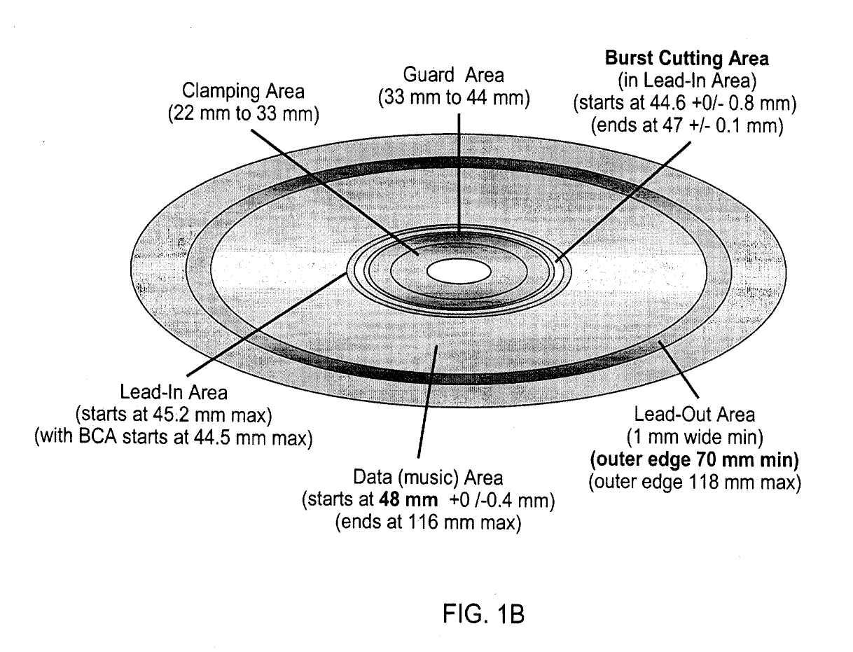

Optical disc format covers more than the annulus of the recording zone wherein content data is recorded. As seen in FIG. 1A, tracks on a optical disc are conventionally divided into a number of zones servicing different functions. For exemplar purposes only, FIG. 1A illustrates the different types of tracks found on a 130 mm optical disc providing for recording by a user. The head out zone 2 (also known as the lead out zone) is comprised of featureless grooves that allow for overshoot after a very rapid seek and provide an area for testing or servo adjustment which is free of interruptions, as well as serving as a coarse-tolerance lead-in for setup of the mastering machine before the format is recorded. The control tracks comprising the standard format part (SFP) 4 and phase encoded part (PEP) 10, are used by the manufacturer to present certain basic information to describe the optical disc, including information that may relate to the media reflectance, the format type (e.g., sample-servo vs. continuous/composite), whether the media is erasable, how much readout power is permissible, and so on. User tracks 8 or recorded tracks are flanked by manufacturer tracks 6 available for the media manufacturer to execute tests (necessarily destructive for write-once medium) and to record useful information specific to the product. Each sectored track is assigned a number, which is noted in all its sector headers. A lead-in region (not shown) of the disc about the central portion of the disc contains table of contents data indicating position of data areas on the disc.

For further illustration, FIG. 1B illustrates the different zones or areas found on a 120 mm DVD read-only optical disc, with conventional representative locations of such areas delineated thereon. It should also be noted that CD read-only optical discs are remarkably similar to DVDs. All tracks arc essentially identical in the sense that all are comprised of optical deformations or marks at discrete locations in one or more layers of the medium. The tracking error signal is derived directly from the location of such optical deformations relative to the focused readout spot.

Representative disc of FIG. 1B includes lead-in area 1, clamping area 3, guard area 5, burst cutting area 7, data area 9 and lead-out area 11, as would be understood by one of ordinary skill in the art. Guard area 5 of FIG. 1B is used during mastering to stabilize the recording system Lead-in area 1 consists of several zones used in preparation for manufacturing, used by the drive for automatic adjustments prior to reading the disc, and used to describe the physical configuration, manufacturing information, and programmatic information supplied by the content provider. Data zone 9 contains any kind of user data. Lead out area 11 is comprised of fixed data not typically available to the end user but useful to maintain tracking in the event of overshoot during a very rapid seek. All areas of the DVD read-only optical disc are candidates for the application of macro- or micro-deposition of the optical state change security materials and the associated advantages thereof, although any such advantages would not ordinarily be found when such materials are deposited in a conventional guard area 5.

Preservation of the lead-out region (at the outer diameter of the disc) is important for successful “mounting” of the disc in the broadest range of drives. Therefore, any process that corrupts the lead-out zone during mounting may be hazardous to the health of the program. Preferably, the macro-deposition should be placed outside any lead-in and lead-out area, or placed not to corrupt the same,.

Macro-deposition may include applying the material in a spin coat, preferably at an outside radius of the disc.

Pit side macro deposition is preferred as the optical state change security materials may be deposited prior to lacquering to more adequately protect the materials for removal.

In order to protect such materials from unintended optical state changes due to exposure to ambient environments, the optical disc preferably also incorporates a filter layer protecting areas in which the optical state change security materials are deposited. Filter material may also be included in the polycarbonate or other substrate comprising the bulk of the disc. For example, ambient light filtering material may be used to protect against unintended activation of the material from its first state to a second state. If applied to the pit side, the lacquer applied may also comprise materials that protect the optical state change security materials by interfering with ambient light or other conditions that may cause the optical state change security materials to change optical state. For example to protect against ambient UV or IR light waves a material absorbing or reflecting such light may be used. The materials may block waves outside that produced by the reading optical laser, e.g. 780 nm, that may also cause an optical change in the optical state change security material.

The optical state change security materials may start out opaque such that a printed pattern that is human readable may be applied. It has been determined that such pattern may consist of dots up to 600.mu. in diameter without disturbing servos. Preferably application of the material is uniform and of high conformality. The pattern may be bleached during playback and become invisible to the laser, permitting valid data to be received. The writing may make the end user believe that the words themselves are important to the protection, much as Microsoft's holographic pit art, rather than the inner workings of an optical copy protection method.

The optical state change security material may also comprise a material that starts out transparent but then turns opaque. Again the materials may be deposited in a manner such that when they become activated by play in the drive, that the end-user sees words. By incorporating an appropriate optical state change security material one may permit the data to be read successfully a number of times, and then require a period of quiescence of the disc before the disc may be read again.

Optical state change security materials that may be used in the present inventions include, without limitation, a material that in response to a signal from the optical reader changes optical state so as to become more or less reflective, to cause a change in refractive index, to emit electromagnetic radiation, to cause a change in color of the material, to emit light, such as by (but not limited to) fluorescence or chemiluminescence, or change the angle of any emitted wave from the optically-changeable security, material in comparison to the angle of the incident signal from the optical reader. As most conventional optical readers use laser-incident light to read the optical medium, it is preferred that the optically-changeable security material be responsive to one or more of the conventional laser wavelengths used in such conventional optical readers. The optical state change security material may be applied to the disc by methods known to those of ordinary skill in the art, including, but not limited to, spin coating or photomasking.

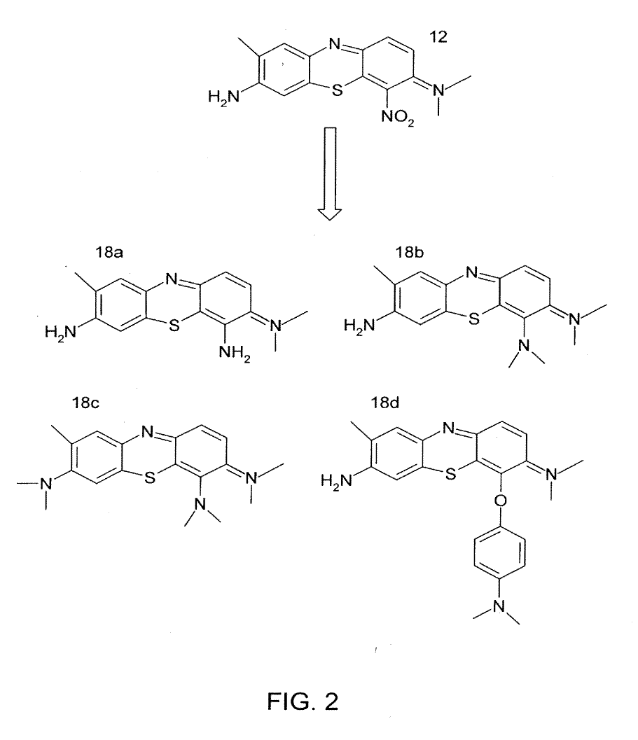

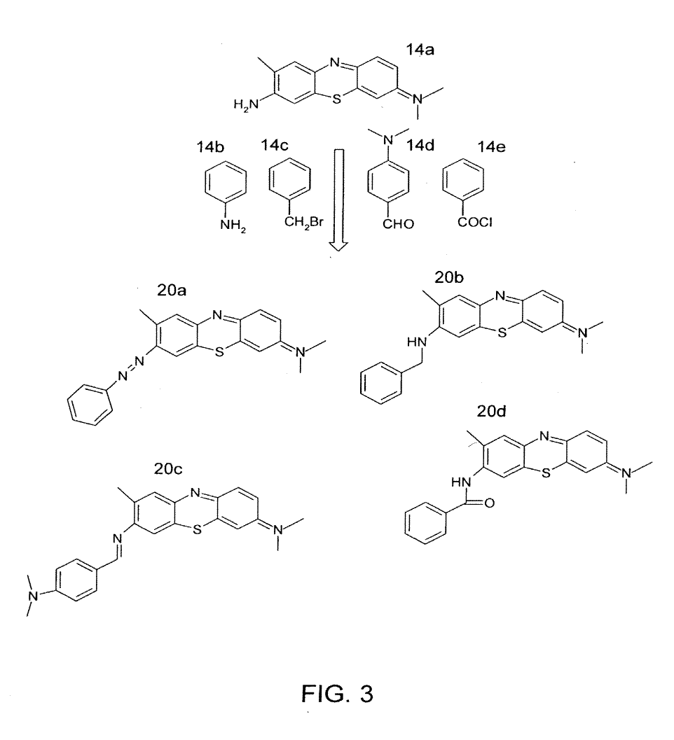

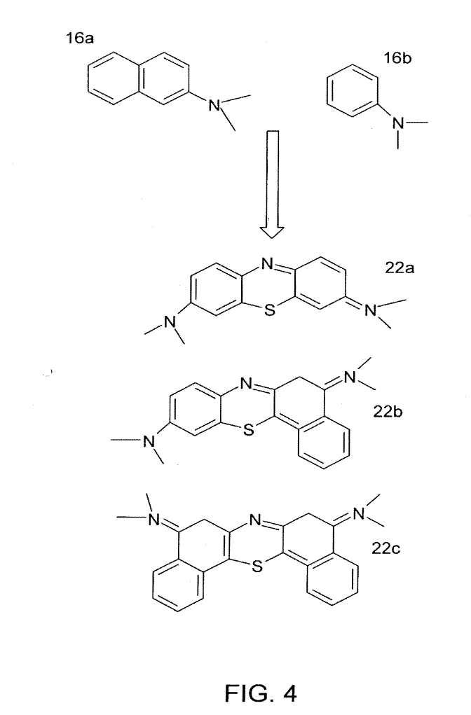

FIGS. 2, 3, and 4 illustrate starting materials (12, 14a-14e, 16a-16b respectively) and desired end-products (18a-18d, 20a-20d, 22a-22c respectively) that represent optical state change security materials, more particularly optically-changeable security materials that transiently change optical state between a first optical sate and a second optical state in a manner such that the change can be picked up by the optical reader upon re-read of the area on the disc where the material is placed. As would be understood by one of ordinary skill in the art, compounds of similar structure as illustrated would be expected to behave optically in a similar manner.

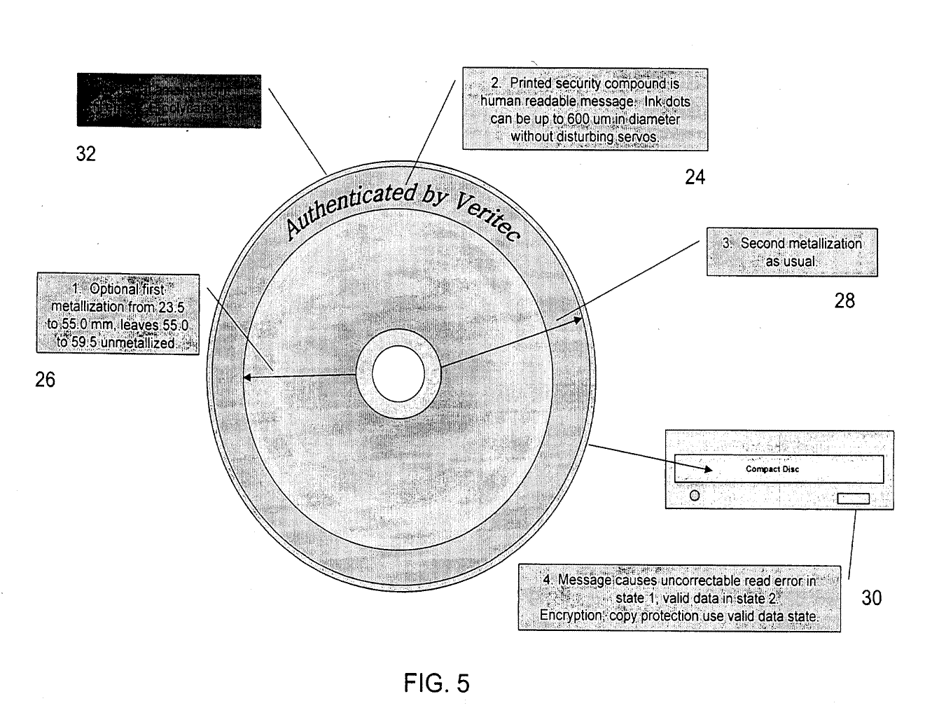

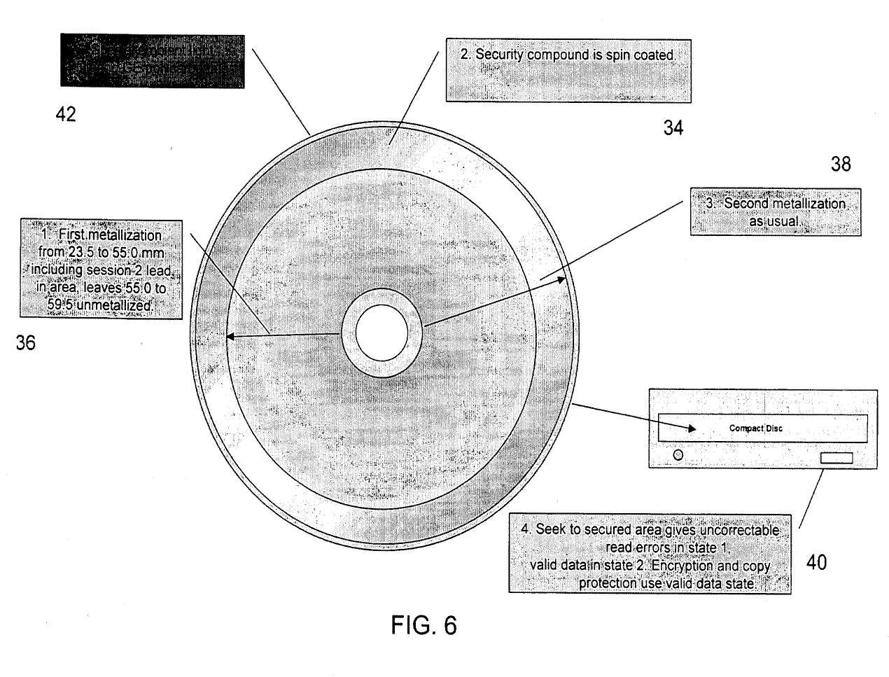

FIGS. 5 and 6 disclose two disc embodiments incorporating macro-deposition of optical state change security materials on optical discs for copy protection.

The embodiment of FIG. 5 incorporates the optical state change security material into a printed human readable message (24) applied along the outer edge of an optical disc, preferably outside of the lead-out zone. In a preferred embodiment the disc is molded and then metallized to form a radius of about 23 to a radius of about 55 mm (26). Between about 55 and about 58 mm there is deposited, for example, but not limited to, by inkjet print, silk screen print, etc., the optical state change security material. Preferably no coating is applied between about 58 and about 60 mm. The entire disc is then re-metallized thereby covering the printed compound (28). Conformal deposition will allow data to be read in one state but not the other. In the embodiment shown, the optical state change security material causes an uncorrectable error to be read in the first optical state, but valid data in the second optical state, with software means, preferably encrypted, being used to allow access to the content upon detection of the same (30). The disc may also comprise a special ambient light filtering substrate that protects the printed security compound from activation due to ambient light exposure (32).

The embodiment of FIG. 6 incorporates the optical state change security material into a spin coat zone located along an outer radii of the disc (34), preferably outside of the lead-out zone. In a preferred embodiment the disc is molded and then metallized to form a radius of about 23 to a radius of about 55 mm (36) including zone 2 lead-in area. Between about 55 and about 58 mm there is deposited the optical state change security material in an annular spin coat (34). A second metallization (38) of the entire disc is then performed to cover such annular spin coat. In the embodiment shown, the optical state change security material causes an uncorrectable error to be read in the first optical state, but valid data in the second optical state, with software means, preferably encrypted, being used to allow access to the content upon detection of the same (40). The disc may also comprise a special ambient light filtering substrate that protects the printed security compound from activation due to ambient light exposure (42).

Operation of the optical medium may be controlled by an authentication algorithm on the optical medium or on a component associated with the optical reader, or the optical reader itself. The two optical states permit the design of a more robust authentication algorithm than in the past.

Operation of the optical medium may also be controlled using the re-seek algorithms internal to the drive. For example, if the optical state change security material is micro-deposited at select positions in the tracking control zones of the disc, the tracking control could be “fooled” by the first optical state of the material to look at a “spoof address” for data that does not exist at that address. When such error is detected, re-seek algorithms internal to the drive will cause the data stored in the tracking control to be re-read. If the optical state change security material is in its second state, and the second state is selected as to allow the underlying data to be read, the new address will be correct and the content on the disc will be able to be read. In a preferred embodiment the material is placed at the subcode level in the lead-in zone thus effecting the table of contents. The material may be placed at the microlevel in the CRC field.

While the invention has been described with respect to preferred embodiments, those skilled in the art will readily appreciate that various changes and/or modifications can be made to the invention without departing from the spirit or scope of the invention as defined by the appended claims. All documents cited herein are incorporated in their entirety herein.

What is claimed is:

1. An optical disc readable by an optical reader comprising:
a substrate with a first major surface with information pits and information lands thereon and a second major surface that is relatively planar, at least a portion of said substrate contains a tracking control region; and
an optical state change security material placed in said tracking control region.

2. An optical disc, in accordance with claim 1, wherein said optical state change security material is placed in subcode in the lead-in section.

3. An optical disc, in accordance with claim 2, wherein said optical state change security material is placed in CRC field.

4. An optical disc, in accordance with claim 1, wherein said optical state change security material is a permanent optical state change security material.

5. An optical disc, in accordance with claim 1, wherein said optical state change security material is a temporary optical state change security material.
